(19) United States
(12) Patent Application Publication
(10) Pub. No.: US 2002/0060883 A1
(43) Pub. Date: May 23, 2002

(54) HARD DISK DRIVE WITH LOAD/UNLOAD CAPABILITY

(76) Inventor: SHOJI SUZUKI, SAN JOSE, CA (US)

Correspondence Address: BLAKELY SOKOLOFF TAYLOR & ZAFMAN LLP, 12400 WILSHIRE BOULEVARD, 7TH FLOOR, LOS ANGELES, CA, 90025

(21) Appl. No.: 09/399,935

(22) Filed: Sep. 21, 1999

(51) Int. Cl. G11B 5/54

(52) U.S. Cl. 360/254.7

(57) ABSTRACT

A disk drive having a mechanism for securing a suspension arm adjacent to the inner diameter region of a disk is described. The securing mechanism engages the suspension arm adjacent the inner diameter region of the disk during load/unload operations. The securing mechanism may be mounted in the drive chassis underneath a subsequently mounted disk. Prior to the mounting of the securing mechanism, a suspension arm may be mounted into the chassis. The securing mechanism is stacked on top of the chassis to engage the suspension arm without the need for lateral adjustment of the suspension arm. The disk may then be mounted into the chassis with the suspension arm pre-unloaded on the securing mechanism.

### FIELD OF THE INVENTION

This invention relates to the field of disk drives and, more specifically, to component assembly in disk drives.

### BACKGROUND

The trend in the disk drive industry is towards small form factor disk drives. A variety of applications exist that require small dimensions (e.g., height, width, and length) of the drive, with height being a primary concern. For example, credit card size form factors have been established to make drives compatible with Personal Computer Memory Card Industry Association (PCMCIA) type computer slots. The height of a disk drive is determined by the size of the drive's components, as well as the number of disks used in the drive. For applications that require smaller drives, single-disk, single side drives have been developed.

Current small form factor disk drive systems typically consist of only one disk and control mechanisms for storing data on the disk. The disk and control mechanisms are contained in a chassis having a base and a cover. Data is stored within concentric tracks on the disk. The reading and writing of data is accomplished with a head “flown” over the disk surface on a thin air bearing, as illustrated in FIG. 1A. As is well known, the actual read/write head is typically attached to a slider body having an air bearing surface that provides the necessary aerodynamic performance. Herein, the term “head” may be used to denote both the head and slider body, depending on the context. The head is positioned over a desired data track using an actuator connected by a suspension arm to the head. The actuator moves the head in a radial direction to the desired track. A spindle motor rotates the disk to position the head at a particular location along the desired track. The head is “flown” by the compressed air between the head (air bearing) and the rotating disk. This develops a boundary layer of air carried by the rotating disk, above its surface, that lifts the head away from the disk in opposition to a loading force from the suspension arm. As such, it is important to maintain precise clearance between the head and the disk surface.

During startup and shutdown times when the head is not actually flying over the disk, contact between the head and the disk may result in data loss in contacted areas. As such, during those times, the head must be positioned such that it does not contact portions of the disk that contain data.

One type of disk drive system dedicates a portion of the disk's surface, referred to as a contact-start-stop (CSS) zone, for the head to reside when the drive is not in operation. With this type of system, the head directly contacts the disk's surface in the CSS zone. In order to increase the storage capacity of the disk, the inner diameter (ID) region or the center region on the disk has been used for the CSS zone. Systems that use the center area on the disk for the CSS zone, however, require a stroke length of almost double that for ID CSS zones. The stroke length is the distance that the suspension arm travels from the outer edge of the disk. The longer stroke length results in a skew angle of the head relative to a track line as the head moves in a radial direction from the outer edge toward the center of the disk. This skew angle changes the profile of the head relative to data tracks and thus, may affect both the flying height of the head and magnetization regions created by the head.

In addition, the use of either an ID region or a center region CSS zone may lead to problems in durability and shock resistance of the disk. For example, external shock forces on the drive during periods of inactivity may cause the head to impact the disk surface in data areas. This may cause damage to the head and/or the disk, that may result in the loss of data.

FIG. 1B illustrates another type of disk drive system that uses a ramp to prevent head contact with the disk during inactive periods and during load/unload operations. The top of the ramp is secured to the disk drive at a position outside the outer edge of the disk. A bottom portion of the ramp extends over the outer diameter (OD) of the disk. Before startup, the head is positioned at the top of the ramp. During startup, the suspension arm slides the head down the ramp so that it flies after clearing the bottom. During shut down, the suspension arm moves the head up the ramp to its parked position at the top. In addition, some disk drive systems also use a guard zone next to the disk region under the ramp. The guard zone is a non-data region used to prevent loss of data due to possible head contact with the disk as the head transitions to flying condition.

One problem with such disk drives is that the larger OD region of the disk is sacrificed to allow the overhang of the ramp and to allow for the use of a guard zone. Because the OD region has a larger area than the ID region, the resulting loss of usable area for data storage may be substantial.

Another type of disk drive system uses a ramp mounted to the center region of the disk. During shutdown, for example, the suspension arm moves the head toward the center of the disk where the ramp catches the suspension arm before the head touches the disk's surface. As previously discussed, one problem with using a center region of the disk for a landing zone (whether directly on the disk's surface or on a ramp) is the greater stroke length required for the suspension arm.

Yet another type of disk drive system provides a ramp mounted to the cover of the disk chassis. When the cover is placed over the chassis, the ramp is positioned on top of the disk over the ID region. One problem with positioning the ramp on the disk side facing the cover is that the alignment tolerance of the ramp with the disk surface is susceptible to manufacturing variations in disk thickness. Assembly of the disk drive with thicker disks will result in lower clearances between the ramp and disk surface that may cause head contact with the disk surface as the suspension arm is moved off the ramp. As such, the use of cover mounted ramps requires tighter manufacturing control of disk thickness.

Another problem with a cover mounted ramp is that it increases the complexity of assembling the drive's components. In order to avoid head contact with the disk surface during drive assembly, the suspension arm should be positioned directly onto the ramp. However, when using a cover mounted ramp, the disk and suspension arm are assembled into the drive prior to placement of the cover. As such, precise lateral motion of the cover during mounting on the chassis is required to pre-load the suspension arm on the ramp. This procedure adds to the complexity of the drive assembly process and, thus, increases manufacturing time and cost.

### SUMMARY OF THE INVENTION

The present invention pertains to a disk drive and a method for assembling the disk drive. The disk drive includes a chassis having a base plate and a disk mounted in the chassis. The disk has an inner diameter region. The disk drive may also include a securing mechanism having an edge residing adjacent the inner diameter region of the disk. The disk drive may also include a suspension arm mounted in the chassis with the edge of the securing mechanism engaging the suspension arm adjacent the inner diameter region of the disk during load/unload operations.

The method of assembling the disk drive includes mounting a securing mechanism into the chassis prior to mounting a disk into the chassis. The method may also include mounting a suspension arm into the chassis prior to the mounting of the securing mechanism. The securing mechanism may be placed onto the suspension arm without the need for lateral adjustment of the suspension arm during mounting.

Additional features and advantages of the present invention will be apparent from the accompanying drawings and from the detailed description that follows.

### BRIEF DESCRIPTION OF THE DRAWINGS

The present invention is illustrated by way of example, and not by way of limitation, in the figures of the accompanying drawings and in which:

FIG. 1A illustrates head flight in a disk drive system.

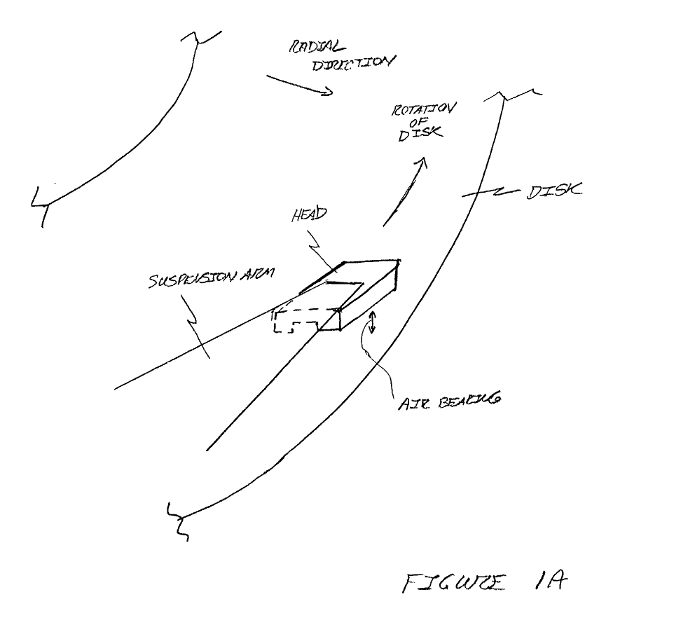

FIG. 1B illustrates a prior art disk drive system.

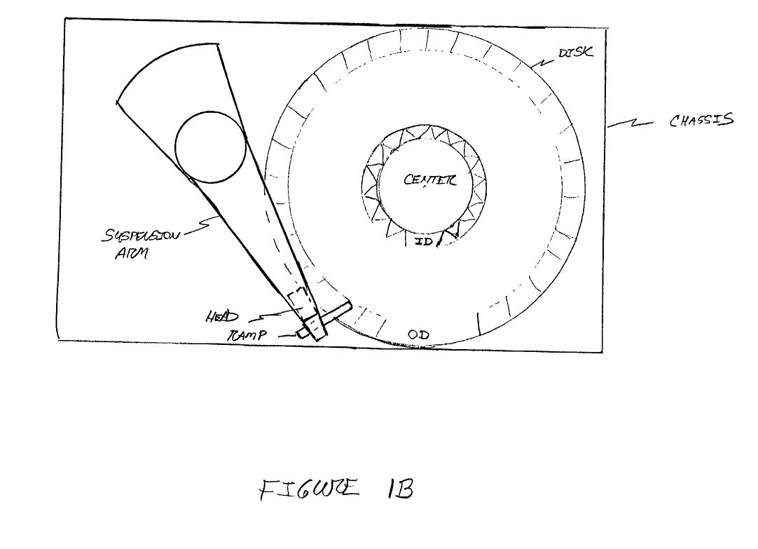

FIG. 2 illustrates one embodiment of a disk drive.

FIG. 3 illustrates one embodiment of a ramp in relation to zones within a disk drive.

FIG. 4 illustrates a cross sectional view of one embodiment of a disk drive.

FIG. 5 illustrates another embodiment of a disk drive.

FIG. 6 illustrates a cross sectional view of yet another embodiment of the disk drive.

FIG. 7 illustrates an exploded view of one embodiment of a disk drive.

### DETAILED DESCRIPTION

In the following description, numerous specific details are set forth such as examples of specific materials, processes, dimensions, etc. in order to provide a thorough understanding of the present invention. It will be apparent, however, to one skilled in the art that these specific details need not be employed to practice the present invention. In other instances, well known materials or methods have not been described in detail in order to avoid unnecessarily obscuring the present invention.

The method and apparatus described herein may be implemented with a disk drive system having one or more disks. For example, the apparatus described herein may be used with drives containing a single disk on which data is stored on the bottom surface of the disk, as discussed in detail below. It should be noted, however, that the method and apparatus are described in relation to a single-sided, single disk drive system only for illustrative purposes and is not meant to be limited only to small form factor drives, single-disk drives, single sided disks, or the bottom side of disks in a drive.

In one embodiment, the disk drive described herein includes a mechanism for securing a suspension arm adjacent to the inner diameter region of a disk. The suspension arm is engaged by the securing mechanisms during load/unload operations. In one embodiment, the securing mechanism may be mounted in the drive chassis underneath a subsequently mounted disk. A suspension arm may be mounted into the chassis, prior to mounting the securing arm, such that the securing mechanism engages the suspension arm without the need for lateral adjustment. The disk may then be mounted into the chassis with the suspension arm pre-unloaded on the securing mechanism.

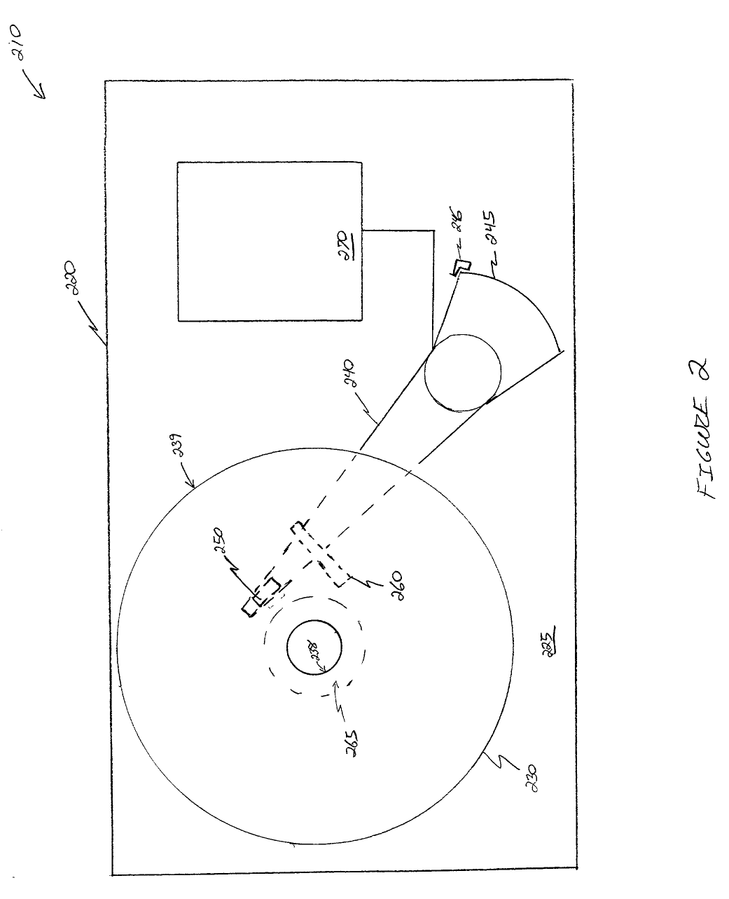

FIG. 2 illustrates one embodiment of a disk drive. A top view of disk drive 210 with its cover (not shown) removed from chassis 220 is illustrated. The dashed lines of a component, or part thereof, in FIG. 2 represents that it is beneath (into the page) another component. The drive components contained within chassis 220 include disk 230, suspension arm 240, actuator 245, head 250, securing mechanism 260, and position control circuitry 270.

In one embodiment, data is stored within concentric tracks on the bottom side (facing into the page) of disk 230. The reading and writing of data is accomplished with head 250 “flown” under the bottom surface of disk 230, on a thin air bearing. Actuator 245 moves suspension arm 240 and, thus, head 250 in a radial direction to a desired track. A spindle motor (not shown) rotates disk 230 to position head 250 at a particular location along the desired track. The position of head 250 is based on signals received from position control circuitry 270. In one embodiment, position control circuitry evaluates track position information incorporated into disk 230 and read by head 220. The positioning of a head over a particular location on a desired track is well known in the art and, accordingly, a more detailed discussion is not provided herein.

In one embodiment, disk 230 is a data disk where the track information is contained on sectors interspersed between data on disk 230. In another embodiment, disk 230 may be a double sided disk with servo information on one side and data on the other. In yet another embodiment, disk drive 210 may include multiple disks in which each side of a disk may have a corresponding head and suspension arm.

In single or multiple disk systems, either side of any disk may be either one of a data side, a data side with servo marks interspersed, or a servo side with servo information. In one embodiment, for example, a single sided disk may be made of plastic and the data side may have a magnetic layer and pre-fabricated grooves or pits for the position signal and/or data storage, similar to a compact disc (CD).

A securing mechanism for each head/suspension arm may be interleaved between the multiple disk and located adjacent the inner diameter of a corresponding disk. The interleaved securing mechanisms may be mounted to various areas of the disk drive chassis through the use of an extension member. In one embodiment, for example, an interleaved securing mechanism may be coupled to a chassis side wall of the disk drive. In another embodiment, an interleaved securing mechanism may be coupled to a base plate in the disk drive. Although the interleaved securing mechanism may be a single integral piece, the securing mechanism for each disk need not be coupled to one another or coupled to the base plate in the same location. Each securing mechanism may be coupled at an appropriate location to some portion of the chassis.

Actuator 245 is connected by a suspension arm 240 to head 250. The suspension arm 240 provides a loading force on head 250 towards disk 230. Head 250 is “flown” by rapidly rotating disk 230 to develop an air bearing, below its surface, that lifts the head away from the disk in opposition to the loading force provided by suspension arm 240.

During startup and shutdown times when head 250 is not actually flying over disk 230, contact between head 250 and disk 230 may result in data loss in contacted areas of disk 230. As such, during those times, head 250 is positioned such that it does not contact disk 230. In addition, external shock forces on drive 210 during periods of inactivity may also cause head 250 to impact the surface of disk 230 in data areas. This may cause damage to head 250 and/or disk 230, potentially resulting in the loss of data. In one embodiment, securing mechanism 260 may be a ramp. In another embodiment, latch 246, coupled to actuator 245, may also be used to lock suspension arm 240 onto securing mechanism 260. The latch may be incorporated into an ID crash stop for suspension arm 240. In alternative embodiments, securing mechanism may be other types of components used to secure suspension arm 240, for example, a pneumatic mechanism to dynamically load/unload the head.

Securing mechanism 260 is used to park suspension arm 240 away from disk 230 in order to prevent head 250 from contacting the surface of disk 230 during inactive periods and during load/unload operations. Securing mechanism 260 is mounted such that the parked head 250 resides adjacent to the inner diameter (ID) region of disk 230. The ID is the disk region near the inner edge 238 of disk 230. The outer diameter (OD) is the disk region near the outer edge 239 of disk 230. Because the radius of the disk increases from inner edge 238 to outer edge 239, the region of disk 230 near the OD will have a larger area than near the ID. By positioning the parked head 250 by the ID of disk 230, the larger OD region of the disk may be used for greater data storage. In one embodiment, securing mechanism 260 is mounted to the spindle motor base plate 265. In alternative embodiments, securing mechanism 260 may be mounted to other fixed structures, for example, the base plate 225 of chassis 220.

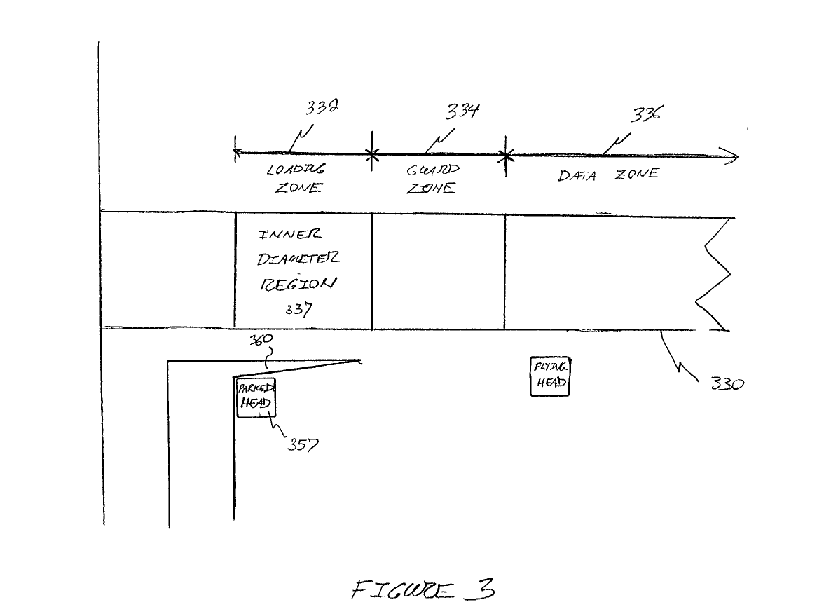

FIG. 3 illustrates one embodiment of a securing mechanism. Securing mechanism 360 is a ramp that extends under disk 330. In this manner, the head 357 may be parked under loading zone 332 adjacent to the inner diameter region 337 of disk 330. The use of the area adjacent the inner diameter region 337 of disk 330 for loading allows for a larger data storage area near the outer diameter of the disk. In another embodiment, a guard zone 334 may be used between data zone 336 and loading zone 332, as illustrated in FIG. 3. When the parked head 357 makes a transition to a flying condition, there may be a chance for contact with disk 330. Guard zone 334 may be used as a transition region in which data is not recorded. The use of a guard zone near ID region 337 may allow for the use of its larger outer diameter region for data storage.

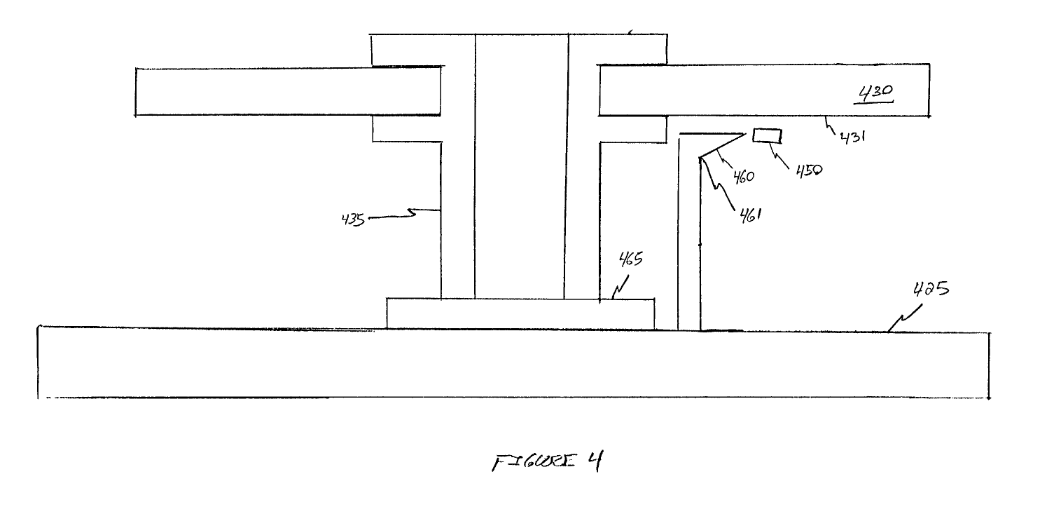

FIG. 4 illustrates a cross sectional view of one embodiment of a disk drive. In one embodiment, securing mechanism 460 is mounted on base plate 425 of the drive chassis. The top 461 of securing mechanism 460 is secured to base plate 425 while the bottom portion of securing mechanism 460 extends over the inner diameter of disk 430. Before startup, head 450 is positioned at the top 461 of securing mechanism 460.

During startup, the suspension arm (not shown) is loaded by sliding head 450 down securing mechanism 460 to its flying position, as shown in FIG. 4. After clearing securing mechanism 460, head 450 is flown by rapidly rotating disk 430 to develop an air bearing between head 450 and surface 431 of disk 430. The airflow lifts head 450 away from disk 430 in opposition to a loading force from the suspension arm. During shut down, the suspension arm is unloaded by moving head 450 up securing mechanism 460 to its parked position (not shown) at top 461.

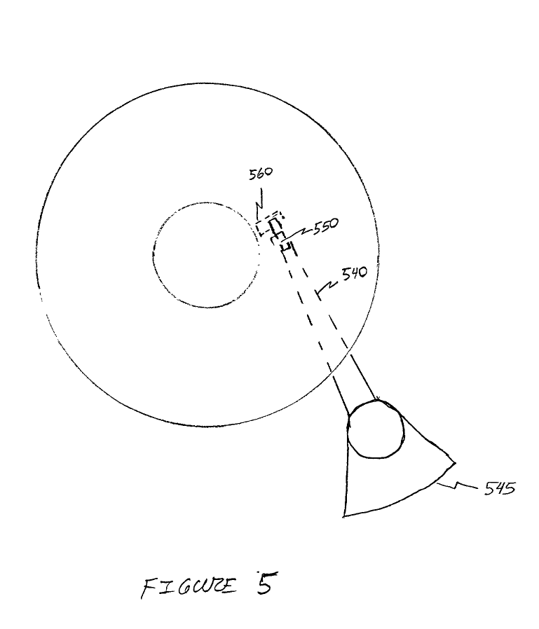

In alternative embodiments, the securing mechanism may be mounted at different positions in the drive chassis. In one embodiment, for example, securing mechanism 460 of FIG. 4 may be mounted to a fixed base plate 465 of spindle 435. In another embodiment, as illustrated in FIG. 5, securing mechanism 560 may be positioned at the end of suspension arm 540 on the side of head 550 opposite that of actuator 545.

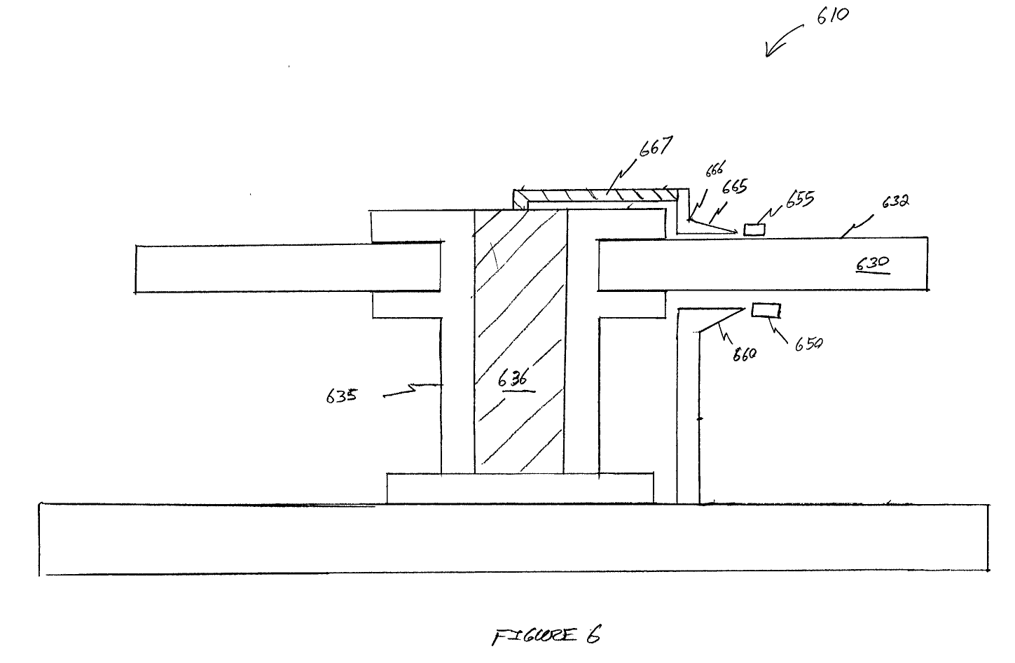

FIG. 6 illustrates a cross sectional view of an alternative embodiment of the disk drive. Disk drive 610 includes a double sided disk 630. As previously discussed, either side of disk 630 may contain data and/or servo information. Each side of disk 630 has a head (i.e., head 650 and head 655) and corresponding suspension arm. Disk drive 610 also includes securing mechanisms 660 and 665 to secure heads 650 and 655, respectively, during inactive periods and during load/unload operations. Securing mechanism 660 may be mounted in a manner similar to that described above for securing mechanism 460 of FIG. 4 or securing mechanism 560 of FIG. 5.

Before startup of drive 610, head 655 is positioned at the top 666 of securing mechanism 665. During startup, the suspension arm (not shown) slides head 655 down securing mechanism 665 to its flying position shown in FIG. 6. As previously discussed, after clearing securing mechanism 665, head 655 is “flown” by rapidly rotating disk 630 to develop an air bearing between head 655 and surface 632 of disk 630. The compressed airflow lifts head 655 away from disk 630 in opposition to a loading force from the suspension arm coupled to head 655. During shut down, the suspension arm moves head 655 up securing mechanism 665 to its parked position (not shown) at top 666.

In one embodiment, the top 666 of securing mechanism 665 is coupled to a connecting member 667. Connecting member 667 extends over spindle 635 and is secured to a fixed (e.g., non-rotating) center 636 of spindle 635. The bottom portion of securing mechanism 665 extends over the inner diameter of disk 630. By using connecting member 667 to maintain securing mechanism 665 over the ID region of disk 630, the stroke length of the suspension arm does not have to be increased, as would be required with a center mounted ramp.

The use of a shorter stroke length reduces the skew angle of head 655 relative to a track line on disk 630 as head 655 moves in a radial direction from the outer edge toward the center of the disk. The skew angle is the angle of deviation between a centerline through head 655 and a line tangential to a circumferential track centerline of disk 630. The reduction in skew angle, by use of a shorter suspension arm stroke length, may improve the write and read performance of head 655 by maintaining a uniform alignment angle and flying height of the head.

In one embodiment, for example, the recording of data in a magnetic media on disk 630 is accomplished based on the principle that if a current flows in a coil of wire it produces a magnetic field. As such, head 655 is made of a magnetic material with a wire winding. A narrow slot (head gap) is cut in head 655 and the field in the vicinity of the head gap magnetizes the magnetic medium on the surface of disk 630. In this manner, data may be written to disk 630.

Head 655 may also be used to read data from disk 630. With an induction head, for example, this is done based on the principle of induction wherein a voltage is induced in an open circuit (like a loop of wire) by the presence of a changing magnetic field. When head 655 is positioned above a spinning magnetic disk 630, magnetic fields emanate from the magnetized regions on disk 630. During the time head 655 is over a single magnetized region, the magnetic field may be approximately uniform. Hence, no voltage develops in the magnetic head. When a disk region passes under head 655 in which the magnetization of the medium reverses, there is a rapid change in the magnetic field, developing a voltage pulse.

Data is read by recovering the shape of this voltage pulse. The shape of this pulse and its ability to be recovered depends on various spacings. These spacings include the distance of head 655 from disk 630 and the angle of alignment between head 655 with a circumferential data track on disk 630. As the angle between the centerline of head 655 and a tangential line to a data track becomes skewed, the shape of the pulse is adversely affected because the head is no longer precisely aligned over a magnetic region. As such, reducing this skew angle, by use of a shorter suspension arm stroke length, may improve the ability of head 655 to write and read data.

Furthermore, the distance of head 655 from disk 630 (i.e., the flying height) may also be affected by the skew angle of head 655. The skew of head 655 may change the profile of head 655 to the oncoming airflow. A different profile of head 655 may alter the behavior of the airflow between head 655 and disk 630 and, thereby, alter the flying height of the head 655. Reducing the skew angle of head 655 may result in a more uniform flying height and, thus, improve the write/read capability of head 655. As such, the positioning of the ramp adjacent to the ID region of the disk may improve the performance of the head by reducing the stroke length of the suspension arm.

It should be noted that the effect of skew angle discussed above is described in relation to an induction head only for illustrative purposes. Similar skew angle problems exist with other read/write technologies, for example, magneto-resistive (MR) heads that use separate heads for reading and writing.

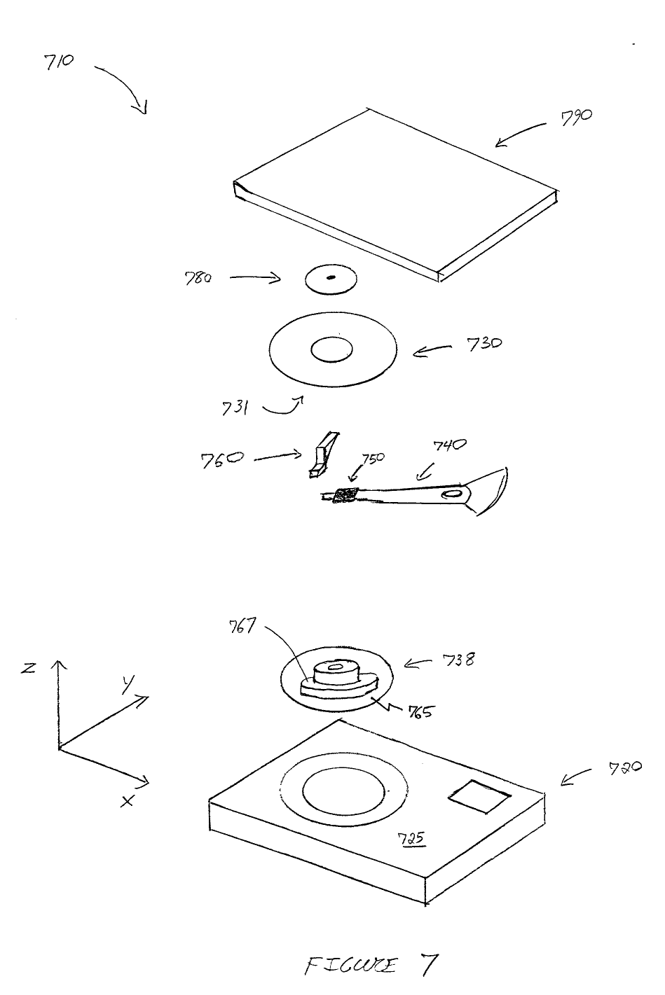

FIG. 7 illustrates an exploded view of one embodiment of a disk drive. In one embodiment, disk drive 710 having one, single sided disk 730 may be assembled by mounting components vertically (i.e., along the z-axis) into chassis 720 without the need for lateral (i.e., along the x-axis or y-axis) adjustment of the components. Disk drive 710 includes chassis 720, spindle motor 738, securing mechanism 760, suspension arm 740, disk 730, clamp 780, and cover 790.

In one embodiment, the components of drive 710 are assembled in order from the bottom of FIG. 7 to its top. The mounting of suspension arm 740 into chassis 720 prior to securing mechanism 760 and disk 730 allows for the vertical placement of subsequent components. Securing mechanism 760 may be lowered directly onto suspension arm 740 (i.e., along the z-axis) such that it engages the suspension arm to place it in an unloaded position on securing mechanism 760. The vertical alignment of the components along the z-axis allows for suspension arm 740 to be pre-unloaded without the need for lateral (e.g., x-axis or y-axis) adjustment of the arm. Disk 730 may then be mounted on spindle 738 above suspension arm 740 and securing mechanism 760. In one embodiment, disk 730 is mounted on spindle platform 767 and coupled to spindle 738 using clamp 780. Cover 790 is used to seal chassis 720.

As such, by mounting securing mechanism 760 on a surface between undersurface 731 of disk 730 and base plate 735 of chassis 720, suspension arm 740 may be pre-unloaded directly down onto the securing mechanism without the need for precise lateral adjustment of either the securing mechanism or suspension arm. In addition, by mounting securing mechanism 760 underneath, rather than on top of disk 730, the height of the drive (i.e., along the z-axis) is unaffected. This aids in the production of small form factor drives that are required in certain system applications. Furthermore, mounting securing mechanism 760 within chassis 720 allows for the use of a flexible cover. In one embodiment, cover 790 is constructed of a viscous material disposed between laminated plates that may absorb vibrations and, thereby, reduce noise in disk drive 710.

Mounting securing mechanism 760 beneath disk 730 may also reduce the complexity of any rework that is required to be performed on drive 710 compared with rework on drives having cover mounted securing mechanisms. During rework of a drive, cover 790 and clamp 780 are removed to gain access to disk 730. Disk 730 may then be removed without the need to remove suspension arm 740 or adjust suspension arm 740 in relation to securing mechanism 760.

It should be noted that precise positioning is needed between head 750 and the recording side of disk 730 for proper operation of the drive. As such, a reference surface in the drive chassis 720 is used to establish a known distance between the bottom of securing mechanism 760 (from which head 750 is engaged) and the undersurface 731 of disk 730. The reference surface may be on components below drive 730 that have planar surfaces parallel to undersurface 731 of disk 730, for example, spindle base plate 765 or chassis base 725. With disk 730 mounted on spindle platform 767, the distance between the undersurface 731 of disk 730 and the reference surface will remain constant, assuming a uniform undersurface 731.

Any manufacturing variations in the thickness of disk 730 will affect the top surface of the disk rather than undersurface 731. As such, by mounting securing mechanism 760 beneath disk 730 and using the undersurface 731 of disk 730 for recording, the tolerance for the disk's thickness is not as critical as with a double sided disk. In addition, by using only undersurface 731 for data storage, the disk may be manufactured by eliminating or altering steps designed to produce a two sided disk, if such elimination or alteration is less costly than double sided processing.

For example, the top side of disk 730 need not be polished, sputtered, textured, or tested, if it is used as a single sided disk. For manufacturing operations that are carried out on both disk sides, the manufacturing process need not be designed to ensure uniformity among both sides and the specifications with respect to the unused side may be much looser. This may allow for greater process margins and lower costs. In one embodiment, the disks may be plated unevenly, for example, by placing the disks in a plating bath at unequal spacing so that the “back to back” sides receive less plating, with the used side having the greater plating. In this way, the side to be used for data storage may be polished to a greater degree to achieve the desired surface roughness and/or to achieve the desired disk flatness, without the constraint of polishing the unused side according to demanding specifications.

In one embodiment, a magnetic recording disk may be fabricated by depositing multiple layers onto a disk substrate by, for example, direct current (DC) magnetron or radio frequency (RF) sputtering. Sputtering is well known in the art; accordingly, a more detailed discussion is not provided herein. In one embodiment, the substrate may be aluminum onto which a nickel phosphorous (NiP) layer is formed by electroless plating or other methods well known in the art. In alternative embodiments, the disk may be constructed from other materials, for examples, glass, ceramic, glass-ceramic, carbon, silicon, titanium, and stainless steel. The surface of the substrate may be polished and may be textured to, among other reasons, reduce head stiction and improve the orientation of the resulting magnetic layer, as is well known in the art.

Multiple layers may be deposited onto the disk substrate. In one embodiment, a chrome (Cr) or Cr alloy underlayer may be deposited onto the substrate. A magnetic layer consisting of a magnetic material, such as a Co—Cr—Ta alloy, may be deposited on top of the underlayer. A protective layer may then be deposited on top of the magnetic layer to protect against factors such as corrosion. After processing, the disk may be subjected to mechanical and/or magnetic testing.

For a double sided disk, the above process may be the same for both sides of the disk. However, when fabricating a single side disk, several processing steps may be eliminated or applied with less precision. In one embodiment, for example, the top side of disk 730 is not used for recording and, thus, need not be polished, sputtered, textured, or tested. In another embodiment, the top side of disk 730 may be coated with a protective layer, such as sputtered carbon, for corrosion protection. By eliminating or reducing the precision of processing steps, the manufacturing time and cost of a disk may be reduced significantly.

In an alternative embodiment, a double sided disk that is processed on both sides may be used. If one side of the disk has too many defects, the other side may still be suitable for use. In yet another embodiment, a double sided disk having both sides suitable for recording may be assembled in a drive. The disk drive includes a single head and suspension arm assembly with which to read/write data onto a single side of the double sided disk. If the side being used for reading/writing is damaged, the drive may be reworked by opening the drive cover and flipping the disk so that other side may be used for reading/writing.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

What is claimed is:

1. A disk drive, comprising:
a base plate;
a disk coupled to the base plate, the disk having an undersurface facing the base plate, the disk having an inner diameter region;
a first suspension arm; and
a first securing mechanism coupled to the base plate, the first securing mechanism disposed between the base plate and the undersurface of the disk, the first securing mechanism to engage the first suspension arm under the inner diameter region of the disk.

2. The disk drive of claim 1, wherein the base plate is a chassis base plate.

3. The disk drive of claim 1, wherein the base plate is a spindle base plate.

4. The disk drive of claim 1, wherein the first securing mechanism is engaged over the inner diameter region of the disk to reduce a stroke length of the first suspension arm.

5. The disk drive of claim 1, wherein the first securing mechanism is a ramp.

6. The disk drive of claim 5, wherein the ramp has a top coupled to the base plate and a bottom extending over the inner diameter region of the disk.

7. The disk drive of claim 6, wherein the base plate is a chassis base plate.

8. The disk drive of claim 6, wherein the base plate is a spindle base plate.

9. The disk drive of claim 1, further comprising:
a second suspension arm;
a spindle having a stationary center region, the disk mounted on the spindle;
a connecting member coupled to the stationary center region, the connecting member extending over the center region toward the inner diameter region of the disk; and
a second securing mechanism having a top coupled to the connecting member, the second securing member having a bottom extending over the inner diameter region of the disk, the second securing mechanism to engage the second suspension arm over the inner diameter region of the disk.

10. The disk drive of claim 9, wherein the second securing mechanism is engaged over the inner diameter region of the disk to reduce a stroke length of the second suspension arm.

11. The disk drive of claim 10, wherein the second securing mechanism is a ramp.

12. The disk drive of claim 1, further comprising:
a chassis having a side wall and the base plate;
a second suspension arm;
a connecting member coupled to the chassis, the connecting member extending over the disk toward the inner diameter region of the disk; and
a second securing mechanism having a top coupled to the connecting member, the second securing member having a bottom extending over the inner diameter region of the disk, the second securing mechanism to engage the second suspension arm over the inner diameter region of the disk.

13. The disk drive of claim 12, wherein the connecting member is coupled to the base plate of the chassis.

14. The disk drive of claim 12, wherein the connecting member is coupled to the side wall of the chassis.

15. A disk drive, comprising:
a chassis having a base plate;
a disk mounted in the chassis, the disk having an inner diameter region;
a securing mechanism having an edge residing adjacent the inner diameter region of the disk; and
a suspension arm mounted in the chassis, the edge of the securing mechanism to engage the suspension arm adjacent the inner diameter region of the disk during load/unload operations.

16. The disk drive of claim 15, wherein the securing mechanism is mounted to the base plate of the chassis.

17. The disk drive of claim 15, wherein the securing mechanism is mounted to a spindle base plate.

18. The disk drive of claim 15, wherein the securing mechanism is a ramp.

19. The disk drive of claim 15, wherein the securing mechanism is coupled to the base plate, the securing mechanism disposed between the base plate and an undersurface of the disk, the securing mechanism to engage the first suspension arm under the inner diameter region of the disk.

20. The disk drive of claim 15, further comprising a connecting member having a first end coupled to the securing mechanism, the connecting member having a second end coupled to the chassis.

21. The disk drive of claim 20, wherein the second end of the connecting member is coupled to the base plate of the chassis.

22. The disk drive of claim 20, wherein the second end of the connecting member is coupled to a side wall of the chassis.

23. The disk drive of claim 15, further comprising:
a spindle having a stationary center region; and
a connecting member having a first end coupled to the securing mechanism, the connecting member having a second end coupled to the stationary center region, the connecting member extending over the center region toward the inner diameter region of the disk.

24. The disk drive of claim 15, further comprising:
a plurality of disks, each of the plurality of disks having the inner diameter region; and
a plurality of securing mechanisms, each of the plurality of securing mechanisms residing adjacent the inner diameter region of a corresponding one of the plurality of disks; and
a plurality of suspension arms mounted in the chassis, each of the plurality of suspension arms to engage a corresponding one of the plurality of securing mechanisms adjacent the inner diameter region of the corresponding one of the plurality of disks during load/unload operations.

25. The disk drive of claim 24, wherein one of the plurality of securing mechanisms is coupled to the base plate of chassis.

26. The disk drive of claim 24, wherein one of the plurality of securing mechanisms is coupled to a side wall of the chassis.

27. A method of assembling a disk drive, comprising:
providing a chassis; and
mounting a securing mechanism into the chassis prior to mounting a disk, the securing mechanism to engage a suspension arm.

28. The method of claim 27, further comprising mounting the suspension arm into the chassis prior to the mounting of the securing mechanism, the securing mechanism placed onto the suspension arm without the need for lateral adjustment of the suspension arm during mounting.

29. The method of claim 28, further comprising mounting a disk into the chassis subsequent to the mounting of the securing mechanism.

30. A method of assembling a disk drive, comprising:
mounting a spindle into a chassis;
mounting a suspension arm into a chassis; and
mounting a securing mechanism into the chassis after the mounting of the suspension arm, the securing mechanism to reside on top of the suspension arm without lateral adjustment of the suspension arm.

31. The method of claim 30, further comprising mounting a disk onto the spindle after the mounting of the securing mechanism, the disk to reside above the suspension arm and the securing mechanism.

32. A disk drive, comprising:
a spindle; and
a disk coupled to the spindle, the disk having a first side and a second side, the first side containing a magnetic recording layer, the second side not containing a magnetic recording layer.

33. The disk of claim 32, wherein the second surface is a non-textured surface.

34. The disk of claim 33, wherein the second surface does not contain any deposited layers.

35. The disk of claim 32, further comprising a protective layer deposited directly onto the second surface.

36. A disk drive, comprising:
a spindle;
a disk coupled to the spindle, the disk having two sides, each of the sides having a magnetic layer; and
a single head configured to write data into the magnetic layer of only one of the two sides of the disk at a time, the disk drive configurable to change the one of the two sides to which the single head writes data.
